(19) United States
(12) Patent Application Publication
(10) Pub. No.: US 2017/0063611 A1
(43) Pub. Date: Mar. 2, 2017

(54) User Configuration Mechanism for Internet-of-Things (IOT)

(71) Applicant: Stringify Inc., Los Gatos, CA (US)

(72) Inventors: Yaron Sheba, Mountain View, CA (US); Michael Alexander Yurochko, Los Gatos, CA (US); David Kenneth Evans, Los Altos Hills, CA (US); Shalin Harshadkumar Patel, San Carlos, CA (US); Jonathan Andrew Morin, San Jose, CA (US); Paul Louis Darby, Linden, CA (US); Joseph Anthony Zacherl, Los Gatos, CA (US)

(21) Appl. No.: 15/184,849

(22) Filed: Jun. 16, 2016

Related U.S. Application Data
(60) Provisional application No. 62/211,647, filed on Aug. 28, 2015.

(51) Int. Cl. H04L 12/24; G06F 3/0488; G06F 3/0486; H04L 29/08; G06F 3/0482

(52) U.S. Cl. CPC H04L 41/0803; H04L 67/12; H04L 41/22; G06F 3/0482; G06F 3/0486; G06F 3/04883

(57) ABSTRACT

A client application includes a user interface for creating and editing complex interactions between IoT elements. Users choose from multiple IoT elements, where each element representing an IoT-enabled device or service. Users drag and drop selected IoT elements into a grid and couple them via one or more connectors. Users edit connectors and specify conditional requirements for some IoT devices to perform actions based on information sourced from other IoT devices. Users implement combinational logic by connecting multiple elements in different ways.

### CROSS-REFERENCE TO RELATED APPLICATION

This application claims the benefit of U.S. Provisional Application No. 62/211,647 filed Aug. 28, 2015.

### BACKGROUND

Field of Disclosure

This invention relates generally to the field of Internet of Things (IoT) devices, and specifically to providing a mechanism for integrating and controlling disparate IoT devices.

Description of the Related Art

In recent years, more and more objects (or things) are being connected to a network infrastructure. This expanded network of connected objects is often referred to as the internet of things (IoT). The IoT enables interoperability between objects connected to the network as well as expanding user's capability to collect information and/or control operations of these various network of objects. The objects (or things) in IoT include not only traditional computers or networking devices, but other devices such as lamps, audio/video (AV) players, thermometers, lawn sprinklers, and vehicles, which were conventionally used as stand-alone devices.

The number and variety of objects (or things) connected the network has grown exponentially over the years. Typically, different types of objects have different capabilities, functions and attributes. Moreover, different objects often communicate using different protocols. Such protocols include device to device (D2D) communication protocols, device to server (D2S) communication protocols and server to server (S2S) communication protocols.

### SUMMARY

Embodiments relate to configuring operation of Internet-of-Things (IoT) devices that using a user interface that enables users to visually perceive rules associated with the operation of IoT elements. A first computing device displays a graphical user interface element representing a first IoT element. An action associated with the graphical user interface element is detected by a user to create or modify a rule defining operation or state of the first IoT element relative to at least a second IoT element. Action information indicating the action performed by the user is sent from the first computing device to a second computing device to cause the second computing device to create or modify the rule stored in the second computing device. The first computing device displays creating or modifying of the rule.

### BRIEF DESCRIPTION OF THE DRAWINGS

FIG. 1 is a high-level block diagram of a system using a unified control scheme, according to one embodiment.

FIG. 2A is a block diagram of a unified control platform according to one embodiment.

FIG. 2B is a block diagram of a unified control platform, according to one embodiment.

FIG. 3 is a block diagram illustrating a user device, according to one embodiment.

FIG. 4 is a graphical user interface diagram illustrating a home screen interface of a client application, according to one embodiment.

FIG. 5 is a graphical user interface diagram illustrating an advanced options menu, according to one embodiment.

FIG. 6A is a graphical user interface diagram illustrating a control interface for an exemplary IoT service, according to one embodiment.

FIG. 6B is a graphical user interface diagram illustrating a control interface for an exemplary IoT device, according to one embodiment.

FIG. 7 is a graphical user interface diagram illustrating a screen of a marketplace where different flows are available, according to one embodiment.

FIG. 8 is an interaction diagram illustrating the operational process associated with processing a user interface (UI) action on a client application, according to one embodiment.

FIGS. 9A through 9D are graphical user interface diagrams illustrating the process of adding an instance to create a new flow, according to one embodiment.

FIG. 10 is a graphical user interface diagram illustrating a process of connecting an instance to an existing flow, according to one embodiment.

FIGS. 11A through 11C are graphical user interface diagrams illustrating the process of moving an instance into an existing flow, according to one embodiment.

The figures depict various embodiments of the present invention for purposes of illustration only.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

IoT is formed using multiple devices and services that exchange data over a network infrastructure. These devices and services may have various attributes, functions and capabilities, and often involves interplay between different parties such as developers or manufacturers of the devices, operators of the services, and end-users of the devices. Such diversity in devices and services as well as different interests of the involved parties have led to the use of different control schemes and protocols for different IoT devices and services (these devices and services of IoT are hereinafter collectively referred to as “elements”).

Embodiments described herein relate to a user interface for controlling and configuring IoT elements, as well as combining them to create action sequences. Each IoT element represents an IoT-enabled device or service. A user controls or configures the operation of an IoT device or service by interacting with its corresponding IoT element in the user interface. Within the user interface, a user can form connections between disparate IoT elements and modify the interactions between them. Based on the way in which IoT elements are connected, a user can implement combinational logic, leading to sophisticated action sequences for IoT elements.

The unified control platform described herein refers to one or more computing devices that enable coordinated operations of IoT elements by processing events and commands of a plurality of disparate IoT elements with different properties, capabilities (e.g., protocol capabilities) and functions.

IoT elements may include network-connected objects for performing various functions. Such network-connected objects may be used for collecting information (e.g., temperature, activity level, and humidity) as well as taking actions (e.g., turning on a device, increasing or decreasing power, and posting information on social networking services). These objects may operate based on different protocols, interfaces, and application programming interfaces (APIs). IoT elements may also include network-based services. These services may be operated by various entities, which may include the manufacturer or developer of IoT objects. Such services may include, but is not limited to, social networking services (e.g., Facebook and Twitter) and services provided by manufacturer's websites.

### Overview of Architecture

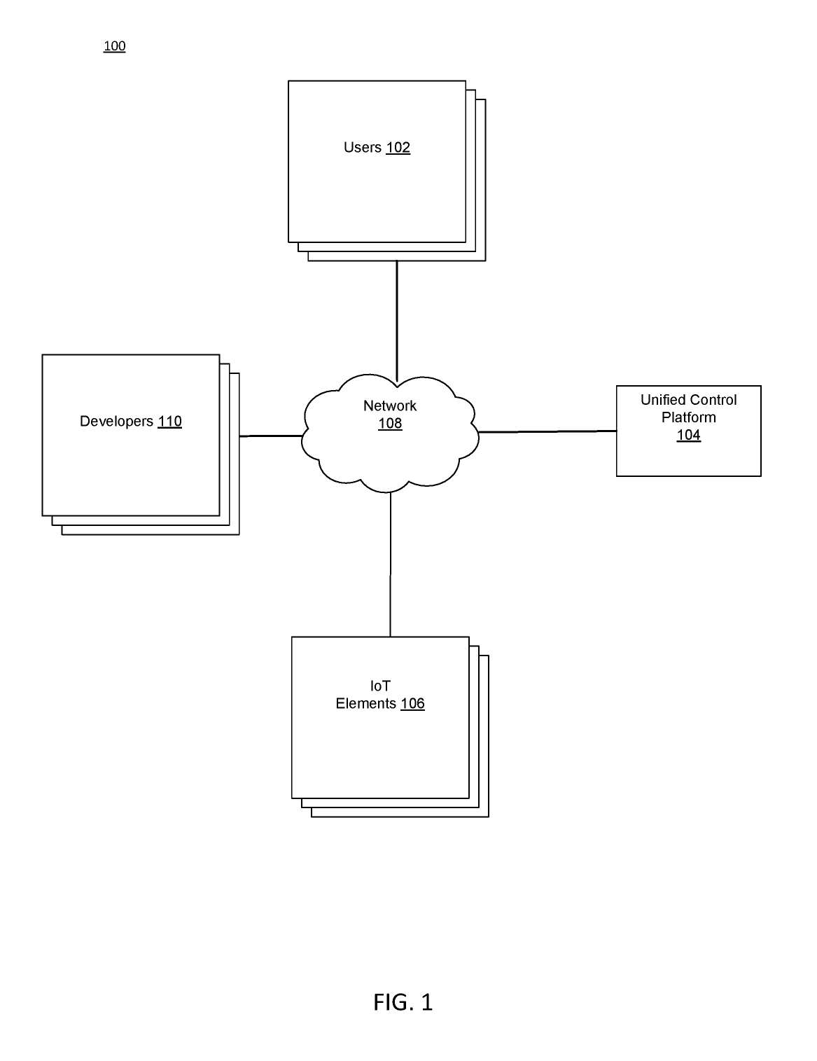

FIG. 1 is a high-level block diagram of a system 100 using a unified control scheme, according to one embodiment. The system 100 may include, among other components, users 102, a unified control platform 104, IoT elements 106, developers 110 and a network 108 connecting these components of the system 100. Although the unified control platform 104 is illustrated in FIG. 1 as a single component, the unified control platform 104 may be a distributed system with multiple computing devices dispersed throughout the network 108.

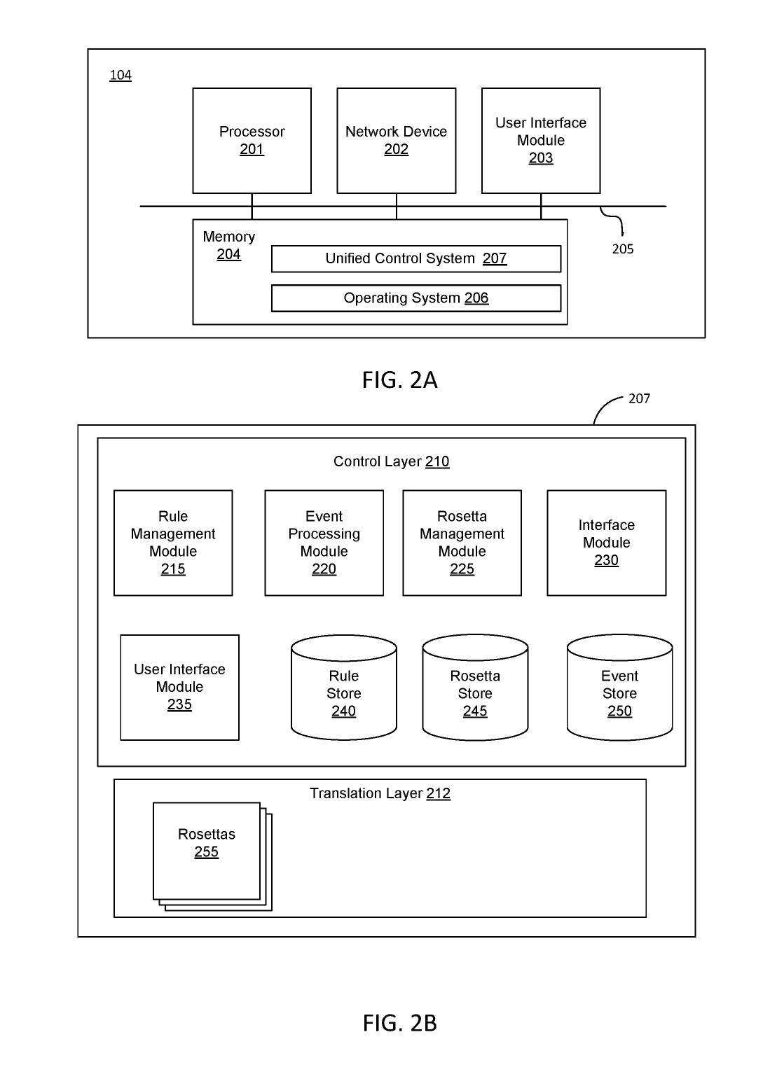

The unified control platform 104 provides a user 102 with integrated control and operation functionality for various IoT elements 106 and also communicates with the users 102 to generate rules defining operations of IoT elements 106 associated with the users 102, as described below in detail with reference to FIGS. 2A and 2B. In some embodiments, the unified control platform 104 is based on an event-driven architecture where interfacing, controls, operation and management of elements 106 are based on events.

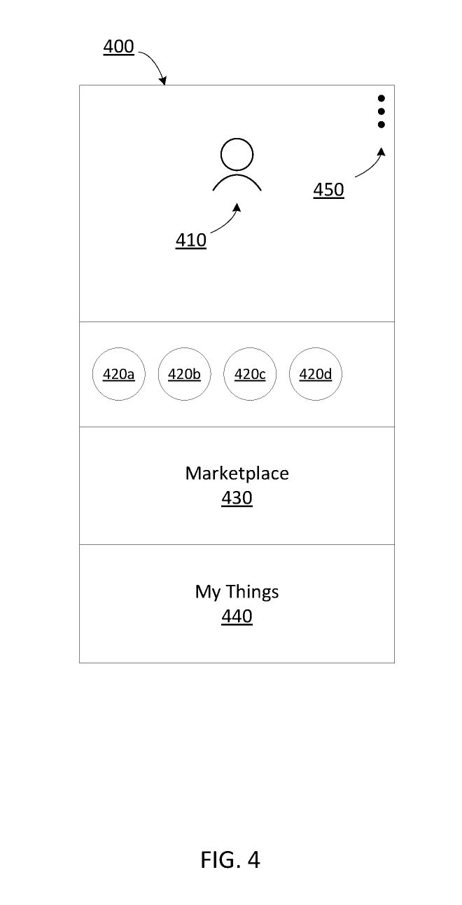

A user 102 may download and install a client application of the unified control platform 104 on a user device to establish rules for controlling the IoT elements 106 using the unified control platform 104, send events to the unified control platform 104 and/or receive messages from the unified control platform 104. Alternatively, the client application may be a browser or other programs preinstalled on the user device, in which case no separate installation of the client application is needed. Each user 102 may have control over or interact with a subset of IoT elements 106. Some IoT elements (e.g., social networking services) may be associated with more than one user 102 while others may be associated with a single user. The user 102 may purchase IoT elements 106 from developers or manufacturers (collectively referred to as “developers 110” hereinafter) and deploy these elements 106 for use at one or more physical locations. The client application executed on the user device may also generate user interfaces on a screen of the user device for generating rules for operating the elements 106, as described below in detail with reference to FIG. 4.

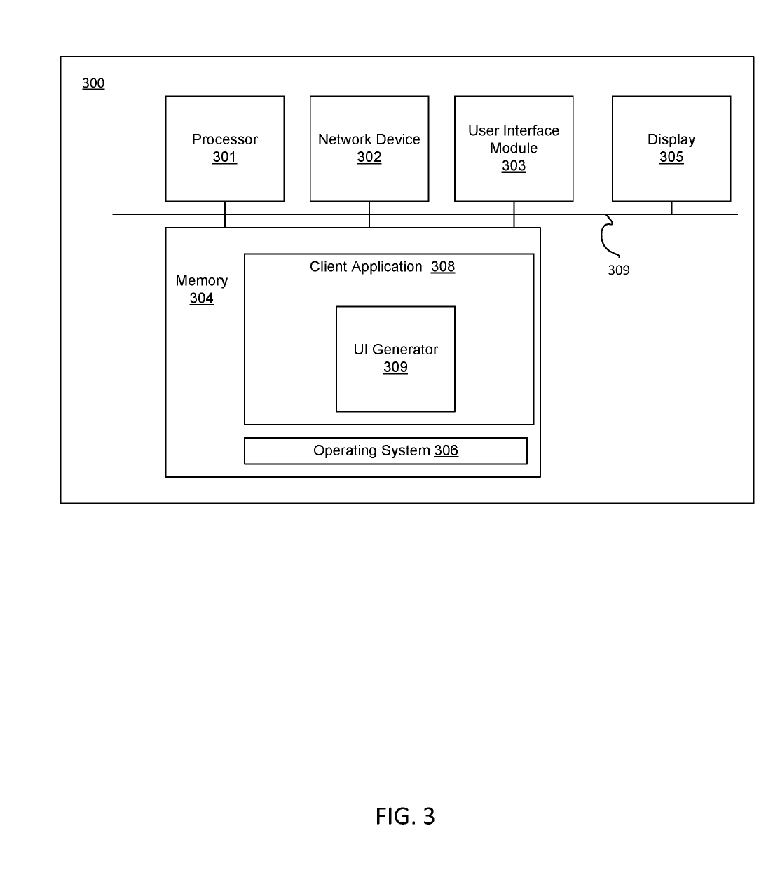

Developers 110 provide rosettas and manifests corresponding to the IoT elements 106. A rosetta is a software component associated with an IoT element to translate element-specific events, protocols, and commands (received or sent to the IoT element) into unified events and commands for processing in the unified control platform 104. The rosetta may also encapsulate computation logic specific to an IoT element, for example, by performing a predetermined computation. Rosettas can be expressed in various languages or frameworks such as Java, Python, C#, Ruby, and Node.js. Each rosetta is associated with a corresponding manifest that describes properties, capabilities, functions and other information that enables the unified control platform 104 to model a corresponding IoT element for interoperability with other IoT elements or users, as described in detail with reference to FIG. 2B and FIG. 3. Developers 110 may be manufacturers of IoT elements 106 or other entities having knowledge about the capabilities, properties and functions of the IoT elements. Developers 110 can create, submit, edit, and update rosettas and manifests of elements 106 and make them available for use in conjunction with the unified control platform 104. By having the developers 110 produce rosettas and manifests, the developers can retain a tight control over how the IoT elements can be used and configured using the unified control platform 104 while relieving the users 102 and the operator of the unified control platform 104 of the need to deeply understand the capabilities, properties and functions of the IoT elements.

The network 108 may be a wireless or a wired network. The network 108 can be based on technologies including, but not limited to, Ethernet, 802.11, worldwide interoperability for microwave access (WiMAX), 4G, digital subscriber line (DSL), asynchronous transfer mode (ATM), InfiniBand, PCI Express Advanced Switching, multiprotocol label switching (MPLS), a Global System for Mobile Communications (GSM), General Packet Radio Service (GPRS), Enhanced Data Rates for GSM Evolution (EDGE), Universal Mobile Telecommunications System (UMTS), Evolution-Data Optimized (EV-DO), Code Division Multiple Access (CDMA), Z-Wave, Zigbee and Bluetooth low energy (BLE).

### Example Architecture of a Unified Control Platform

FIG. 2A is a block diagram of the unified control platform 104 according to one embodiment. The unified control platform 104 may include, among other components, a processor 201, a network device 202, a user interface module 203, a memory 204 (i.e., a non-transitory computer-readable storage medium) and a bus 205 connecting these components.

The processor 201 executes instructions to perform operations on the unified control platform 104. At least part of the executed instructions is stored in the memory 204.

The memory 204 stores software modules including an operating system 206 and a unified control platform 207. The operating system 206 manages resources available in the unified control platform 104. The unified control platform includes software modules for configuring and executing rules for controlling IoT elements 106, and interacting with developers 110 and users 102, as described below in detail with reference to FIG. 2B.

The network device 202 may include hardware, software, firmware and a combination thereof for communicating with the elements 106, the users 102 and the developers 110 over the network 108. The network device 202 may be embodied as a network card.

FIG. 2B is a block diagram of the unified control platform 207, according to one embodiment. The unified control platform 207 may include, among other software components, a control layer 210 and a translation layer 212. The control layer 210 is responsible for interacting with the user 102 to set up rules for operating the elements 106 and executing these rules after they are set up by the user 102. The translation layer 212 serves as a bridge between the control layer 210 and elements 106 using unified events and commands.

The control layer 210 may include, among others, a rule management module 215, an event processing module 220, a rosetta management module 225, an interface module 230, a user interface module 235, a rule store 240, a rosetta store 245, and an event store 250. Other embodiments may have different and/or additional modules other than what is described with reference to FIG. 2B. Furthermore, the functionalities of these modules can be distributed among the modules in a different manner.

The translation layer 212 includes a plurality of rosettas 255 to interface with the corresponding elements 106. In one or more embodiments, the translation layer 212 includes the same number of rosettas 255 as the number of IoT elements 106 so that a one-to-one relationship is established between each rosetta 255 and its corresponding IoT element 105. In other embodiments, a single rosetta may represent multiple IoT elements.

A rosetta may include, for example, three parts: an IoT element connector, a data processor and a control layer connector. The IoT element connector is software code that interfaces with a corresponding IoT element and communicates with the corresponding IoT element using an API specific to the element. The control layer connector is software code that connects and interfaces with the control layer 210. The control layer connector sends events and commands to the control layer 210 and receives unified events and comments from the control layer 210 using an API that is common across different rosettas. The data processor is software code that performs data processing including, parsing, computing, and polling.

In one or more embodiments, a rosetta may be deployed for an IoT element that is not yet physically deployed. Instead, a rosetta may represent a virtual IoT element and enable a rosetta management module 225 to simulate actual deployment of the element 106.

The rule management module 215 creates, stores, and manages rules for controlling elements 106 per instructions from the users 102. A rule describes conditions (e.g., occurring of triggering events) and actions as a result of satisfying certain conditions. For example, a rule may describe turning on an IoT element (action) when a certain time is reached (condition). The rule management module 215 may associate a user with rules created by the user and store such association in the rule store 240. In addition, when a user requests updating or deleting of an existing rule, the rule management module 215 updates or removes the existing rule in the rule store 240.

The rule store 240 is a storage module for storing the created rules. The rules stored in the rule store 240 may be accessed by the event processing module 220 to process events and generate commands. The rule store 240 may also identify users authorized to use each rule.

The event processing module 220 processes events to control the elements 106 according to the rules stored in the rule data store 205. Events are messages communicated within the unified control platform 104 and may indicate, for example, temperature changes, receiving of a new email, and reaching a certain time limit. Events may be generated by rosettas 255, the translation layer 212, the rule management module 215 as well as the interface module 230. The event may be in the form of an event packet which includes, for example, a source of the event, a destination of the event, a timestamp indicating when the event packet was generated, a protocol associated with the event, the user associated with the event, and a payload. The payload describes additional information about the event and content dependent on the event's protocol. The file content of the event packet may be expressed in JavaScript Object Notation (JSON), or a similar widely-used format. In some embodiments, events are not processed in real time. In such embodiments, event packets not yet processed may be stored in the event store 250 and then be routed to proper destinations for further processing. After processing the events, the event processing module 220 may send commands, when conditions are met, to the rosettas 225 to cause predetermined actions at the corresponding elements 106.

The rosetta management module 225 registers, stores, and manages rosettas and their corresponding manifests. A manifest provides information associated with various aspects of a corresponding rosetta, and is described below in detail with reference to FIG. 3. In some embodiments, the rosettas 255 are hosted and deployed in the translation layer 212 after being registered by the rosetta management module 225. The rosettas 255 are included in the translation layer 212 after being registered by the rosetta management module 225. In other embodiments, the rosettas 255 are hosted in other platform (e.g., a trusted partner server) or even the IoT elements themselves.

After being registered, rosettas 255 interface between the control layer 210 and the IoT elements 106 using a common API. In one or more embodiments, the rosettas 255 maintain connections with the elements 106 and periodically retrieve updates from the elements 106 to maintain the states of the elements 106.

In some embodiments, an IoT element 106 can interface via one or more rosettas, some of which may be provided by different developers. Each of the rosettas corresponding to the same IoT element 106 may enable users to take advantage of different sets of functionalities or capabilities of the IoT elements.

The rosetta management module 225 registers a rosetta when it becomes newly available to the unified control platform 207 or when the rosetta becomes updated. When a rosetta 255 is submitted by a developer, the rosetta management module 225 registers the rosetta 255 using manifest corresponding to the rosetta 255. During the registration process of a rosetta, the rosetta management module 225 may (i) assign a rosetta identify (ID) to the rosetta, (ii) store the rosetta 255 with the associated ID in the rosetta store 245, (iii) retrieve manifests associated with the rosettas, (iv) extract information from the manifests, (v) make a subset of information in the manifests available to the client application on user devices and (vi) identify security methods and protocols (e.g., OAuth and OAuth2) if any, to be use used with an IoT element corresponding to the rosetta. In one embodiment, the rosetta 255 is registered at the rosetta management module 225 by calling a specific uniform resource locator (URL) and submitting a developer API key for authentication to the rosetta management module 225. The Rosetta and associated manifest can be registered via a development tool/portal at time of submission, or the Rosetta could send the manifest to the server via an initial Rosetta registration process. Standard security protocols such as, but not limited to: SSL/TLS, OAuth/OAuth2 would be employed.

The interface module 230 manages connections with the users 102 and developers 110. The interface module 230 performs user authentication and user account management functions so that authorized users and developers can access, modify and remove rules, rosettas and manifests in unified control platform 104. The interface module 230 (i) sends messages from the event processing module 220 to a user, (ii) throttles and load balances incoming requests to prevent requests overloading the unified control platform 104, and (iii) directs a request to a proper module for further processing. For example, a client's request to create a rule is directed to the rule management module 215 for processing, and a developer's request to update a rosetta is directed to the rosetta management module 225 for processing.

In addition, the interface module 230 provides a subset of information in the manifest to the client application. The subset of information may include all or part of metadata, all or part of API details and user interface (UI) information. The UI information enables the users 102 to set rules and configure the elements 106 using, for example, a graphical user interface on the user device. The interface module 230 may also provide software code for preparing manifests to the developers 110. In one or more embodiments, the developer may decide which parts of the metadata should be sent to the client application 408 while other parts of the metadata should be retained in the unified control platform 104 and not made publicly available.

### Example Structure of Manifest

A manifest is associated with a rosetta to describe various information associated with the rosetta or its counterpart IoT element. The manifest may be available from a source separate from the rosetta. For example, when a developer provides a rosetta, a manifest is provided along with the rosetta. Manifests are generally generated and provided by a developer who understands various aspects of the IoT elements or its rosetta. In most cases, the manifests are provided by the same entity that develops their corresponding rosettas.

A manifest may include the following fields: (i) metadata, (ii) API details, (iii) UI information. The API details include a security information subfield. The UI information includes subfields: (i) control information, and (ii) triggers and actions. These are examples, and other manifests can include additional data fields or omit some of these data fields. An example manifest and pseudo-codes associated with the manifest is provided in Appendix A.

The metadata describes the attributes of an IoT element or its associated rosetta. Example attributes include manufacturer of the element, model or version number of the IoT element, the operating system of the element, possible states of the IoT element (e.g., on and off states), and protocols compatible with the IoT element. The metadata may also contain URLs to other rosettas (e.g., additional JSON documents) which enable or disable certain functionality of the IoT element. The metadata also describes relationships of its counterpart IoT element to other IoT elements such as a hub required for operation of the counterpart IoT element.

The API details include information about the API installed on the IoT element. For example, the API details indicate URLs to access in order for a rosetta to obtain information from a source (e.g., weather information from a weather service). The API details also contains, but is not limited to, credentials such as an access tokens, refresh tokens, and keys used to access the service.

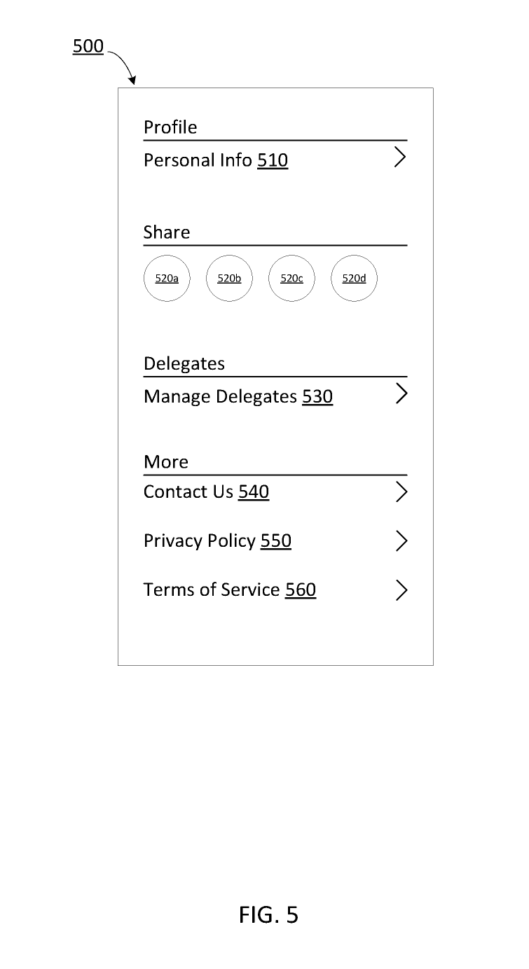

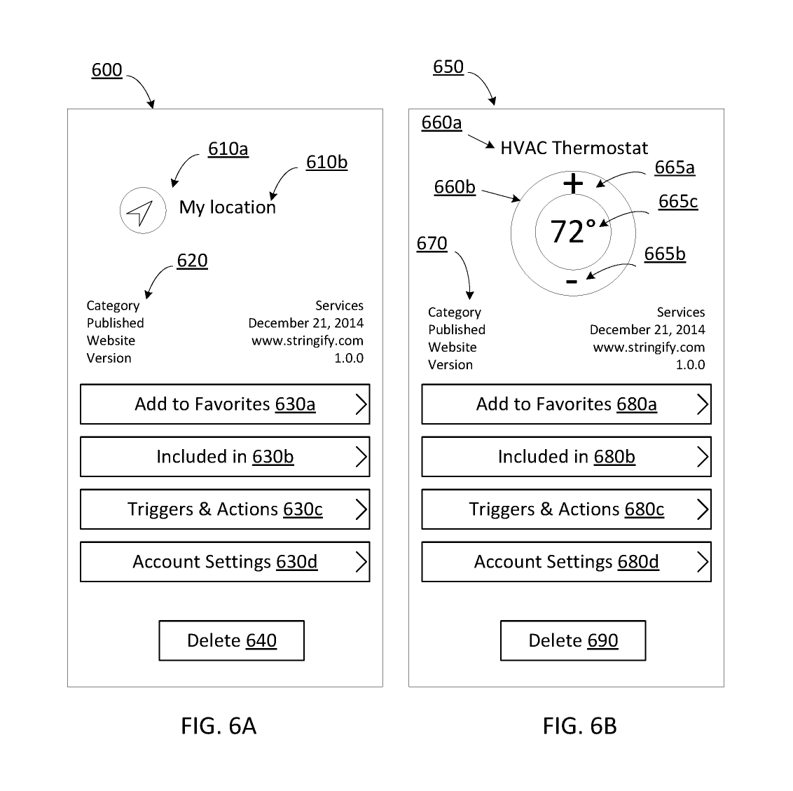

The security information describes the security-related items such as authentication methods. Many IoT elements need to be authenticated before they can be controlled or accessed by a user. For example, a user may have to log into a user account to control a thermostat. The security information describes how a user and/or the unified control platform can obtain authentication for the operation and control of an IoT element. Example data for the security information may include, among other information, required information for authenticating a user authorized to use the IoT element (e.g., user name and password), encryption scheme for communicating with the IoT element. The unified control platform may use security information to construct an appropriate authentication interface for the particular element. The UI information describes the user interface, layout, and related UI details associated with a rosetta or its counterpart IoT element. The UI information may be extracted by the rosetta management module and be sent to the user device via the interface module so that certain UI elements (e.g., graphical user interface elements) may be displayed to the user at the user device, as described below in detail with reference to FIGS. 5 through 6B.

The UI information may include information such as positions of a UI element, dimensions of the UI element, identification of UI element (e.g., image, checkbox, dropdown menu), properties associated with the UI element (e.g., appearance, value and range). Examples of UI elements and pseudo-codes associated with the UI elements are provided in Appendix B.

The control information and triggers and actions include information about how IoT elements can be operated. The control information describes methods of operating and controlling IoT elements directly. A method refers to a function or operation that can be taken at an IoT element. For example, a rosetta for a lamp may support an ‘on’ method for turning on the light, an ‘off’ method for turning off the light, and a ‘brightness’ method for adjusting brightness of the lamp. The triggers and actions describe event-based processes of operating and controlling IoT elements. Specifically, the triggers and actions include information about triggering events that trigger the control and/or operation described in the control information 309 as well as actions performed by IoT elements as a result of the triggering events. An event is an action or occurrence detected and reported by a rosetta for handling by the event processing module. For example, a rosetta of a lamp generates an event notifying to the event processing module that a light was turned off.

The methods specified in the control information and triggers and actions indicate to the unified control platform how an element can be operated. The event processing module of the control layer uses the information provided by the control information and triggers and actions to generate events and commands that can be translated by the rosetta to send out element-specific events and commands to the corresponding IoT element. The triggers and actions also describe events associated with the IoT element.

### Example User Device

FIG. 3 is a block diagram illustrating a user device 300 for accessing the unified control platform 104. The user device 300 is used by a user 102 to define rules, send events and commands to the unified control platform 104, and receive messages from the unified control platform 104. The user device 300 may be a computing device such as a cellphone, a smart phone, a tablet, a laptop and a wearable device. The user device 300 may include, among other components, a processor 301, a network device 302, a user interface module 303, a display 305, a memory 304 (i.e., a non-transitory computer-readable storage medium), and a bus 309 connecting these components.

The processor 301 executes commands to perform various operations on the user device 300. The operations include processing messages received from the unified control platform 104 and communicating with the unified control platform 104 to define and execute rules for controlling the IoT elements 106.

The network device 302 may include hardware, software, firmware and a combination thereof for communicating with the unified control platform 304 over the network 108. The network device 302 may be embodied as a network card.

The user interface module 303 is hardware that may be combined with software and/or firmware for receiving user input from the user. The user interface module 303 may include touch screens, keyboards, keypads, and pointing devices (e.g., mouse).

The display 305 is hardware that may be combined with software and/or firmware to display user interface elements to the user. The display 305 may be embodied using liquid crystal display (LCD), organic light emitting diodes (OLED), and bistable display technology.

The memory 304 stores software modules including an operating system 306 and a client application 308 for the unified control platform 104. The operating system 306 manages resources available in user device 300. The client application 308 is a software module for communicating with the unified control platform 104 to perform various operations associated with controlling the IoT elements 106. The client application 308 enables users to access the unified control platform 104, set up rules to operate one or more IoT elements 106, and display messages from the unified control platform 104 to the user.

In one embodiment, the client application 308 includes a user interface (UI) generator 309 for generating various graphical user interface elements. The UI generator 309 generates and displays various screens on the display 305 such as (i) a grid screen used for configuring rules for operating the IoT elements 106 and (ii) a rosetta/element detail screen showing events, actions, functions and capabilities of an IoT element. Such grid screen or the rosetta/element detail screen is generated using the UI information extracted from a corresponding manifest.

### Example User Interface for Home Screen of the Client Application

FIG. 4 is a graphical user interface diagram illustrating a home screen interface of a client application, according to one embodiment. A graphical user interface screen 400 includes a user icon 410, selected IoT elements 420a, 420b, 420c, and 420d, an area representing a marketplace 430, and an area representing “My Things” 440.

Each of the IoT elements 420a, 420b, 420c, and 420d represents an IoT device or service that is compatible with the platform. The elements 420 may be labeled as a “Favorites” list, allowing the user to conveniently control often-used associated devices or services.

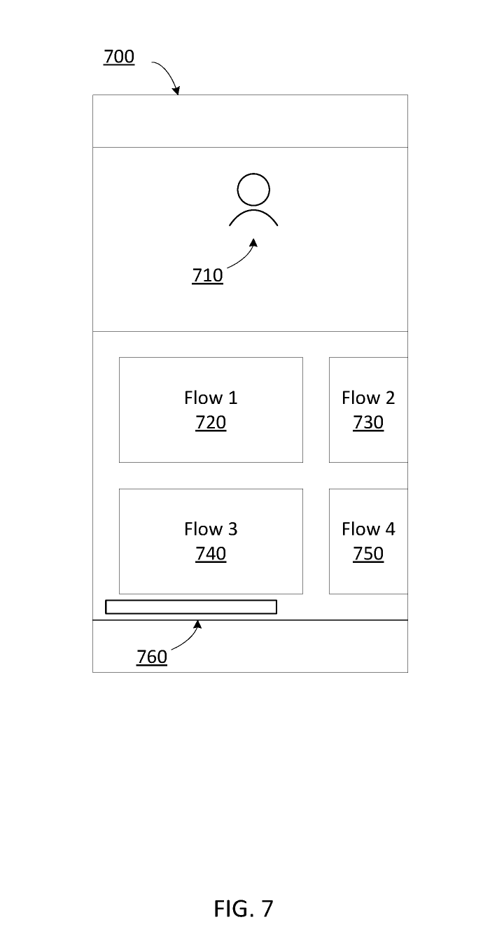

The marketplace 430 allows users to view and acquire content created by other users of the platform. The details of the marketplace 430 are described below in detail with reference to FIG. 7.

“My Things” 440 enables users to control their own IoT devices and services. This control includes individual management of elements, as well as creation of flows involving multiple elements. Finally, an expander icon 450 in the top-right corner of the graphical user interface screen 400 allows the user to access an advanced options menu, which is described below in detail with reference to FIG. 5.

FIG. 5 is a graphical user interface diagram illustrating an advanced options menu, according to one embodiment. The graphical user interface screen 500 can be accessed via the expander icon 450 in FIG. 4. The graphical user interface screen 500 includes a link to Personal Info 510, in which the user can edit his/her personal details such as name, address, and so on. The graphical user interface screen 500 next includes a link to elements 520a, 520b, 520c, and 520d. Each of the elements 520 represents a social media service configured to interact with the unified control platform.

Next, the graphical user interface screen 500 includes a link to Manage Delegates 530. Users can use this link 530 to provide other users access to their elements and associated control interfaces. The graphical user interface screen 500 next includes standard account information links common in client mobile applications, such as “Contact Us” 540, “Privacy Policy” 550, and “Terms of Service” 560.

### User Interface for Controlling IoT Devices

FIGS. 6A and 6B are graphical user interface diagrams illustrating control interfaces for selected IoT elements, according to one embodiment. These control interfaces are accessible via links in the home screen or in the advanced menu, as depicted in FIGS. 4 and 5. FIG. 6A is a graphical user interface diagram illustrating a control interface for an example IoT service, according to one embodiment. The graphical user interface screen 600 is used for controlling conditions and actions associated with an IoT element associated with location-based service. A location icon 610a indicates the type of IoT service for which controls and information are being displayed; a title is indicated as “My Location” 610b. A segment 620 displays select relevant information, including the category in which the service is organized, when it was published, its source website, and its version.

Additionally, the graphical user interface screen 600 includes further controls 630 that allow a user to configure how the location service 610 is configured and used. These controls include “Add to Favorites” 630a, which a user can click on to add the IoT element to a list of favorites. The favorites list is easily accessible throughout the user interface to allow for convenient access to commonly-used IoT elements. Next, an “Included in” button 630b tells the user where the IoT element is in use throughout the unified control platform. This is followed by a “Triggers and Actions” button 630c, in which a user can manage and configure (a) the events or conditions which trigger an action to be performed by the IoT element and (b) the actions themselves. Below 630c is an “Account Settings” button 630d which allows the user to view and configure settings relating to their user account which are specific to the IoT element. Finally, a “Delete” button 640 allows the user to remove the IoT element and prevent information associated with the IoT element from being displayed on the user device.

Many IoT elements represent physical devices. FIG. 6B is a graphical user interface diagram illustrating a control interface for an exemplary IoT device, according to one embodiment. The graphical user interface screen 650 includes a title 660a for the control interface, given here as “HVAC Thermostat.” The title 660a is accompanied by a graphical interface 660b. The interface 660b is configured to resemble the control interface of the associated physical device. As such, the interface 660b features a plus sign 665a and minus sign 665b for increasing or decreasing a set temperature. The current temperature 665 measured by the physical device is displayed in the center of the graphical interface 660b.

The graphical user interface screen 650 also features a segment 670, which displays select relevant information, including the category in which the service is organized, when it was published, its source website, and its version. Additionally, the screen 650 includes further controls 680 that allow a User to configure the settings and usage of the location service 610. These controls include “Remove from Favorites” 680a, “Included in” 680b, “Triggers and Actions 680c”, and “Account Settings 680d.” These controls are substantially the same as controls 630a through 630d discussed in FIG. 6A. Finally, a Delete button 690 is provided, which allows the User to remove the element from being displayed on the user device.

### Browsing Flows Created by Other Users

Users acquire and consume flows created by other users. These flows are available through a marketplace which is organized and maintained by administrators of the unified control platform 104. Users who create flows for consumption by other users may provide them for free or may charge a nominal amount, similar to how applications are sold in other common mobile marketplaces. A user browsing the marketplace can view on one screen all of the flows created by a single other user of the platform.

FIG. 7 is a graphical user interface diagram illustrating a screen of a marketplace where different flows are available, according to one embodiment. The screen 700 features a user icon 710 which uniquely identifies the creator of the flows.

Below, the screen 700 includes multiples flows Flow 1 720, Flow 2 730, Flow 3 740, and Flow 4 750. Each flow is created by the user identified by the icon 710. A user in search of new flows to add to his or her client application may browse through and acquire one or more of these flows. A scroll bar 760 allows the user to view all of the flows produced by the creator 710. A user can click on an individual flow to view which IoT elements it contains and how they are configured to interact. If a user wishes to acquire a flow, he or she can purchase or download the flow. Upon acquisition of the flow, the user can modify and activate it for use with IoT devices and services owned by the user.

### Interaction Between a Client Application and the Unified Control Platform

Users interact with the user interface of the client application by performing common touch actions on a display screen of a client device. These user actions include swiping, tapping, and dragging and dropping. Each action involves one or more elements, each element representing an IoT service or device compatible with the platform. Validation of each such action involves both the client application and the unified control platform.

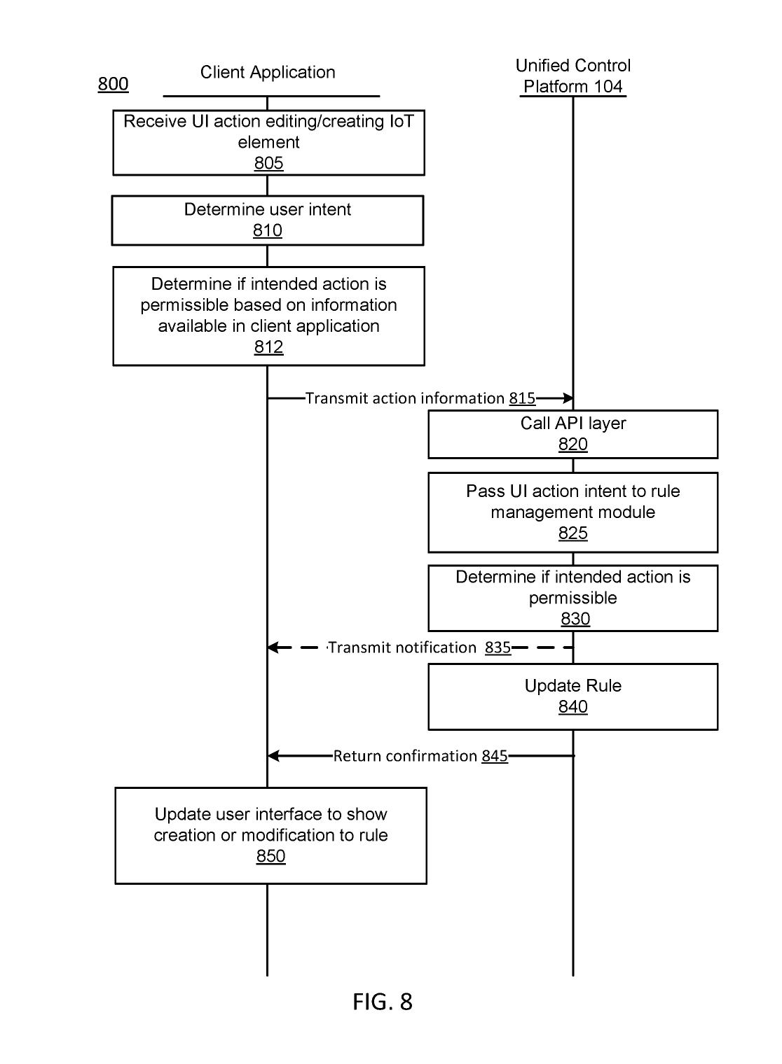

FIG. 8 is an interaction diagram illustrating the operational process associated with processing a user interface (UI) action on a client application, according to one embodiment. The client application receives 805 a UI action, which involves editing or creating a particular IoT element, or connecting one IoT element to another.

The client application determines 810 the user's intent. In one embodiment, the client application determines 812 if the intended action is permissible based on information available in the client application. Such information on permissibility may be part of manifest associated with an IoT element being manipulated on the client application.

If the client application determines that the action is not permissible, then the client application notifies the user that the intended action cannot be taken. In contrast, if the action is permissible, the client application generates action information indicating the intended action and transmits 815 the action information to the unified control platform.

The platform receives the action details via interface module 230 and calls 820 an API layer with the action information. The action information is subsequently passed 825 to a rule management module 215 within the unified control platform. The rule management module 215 determines 830 whether the action indicated in the action information can be taken based on, among other information, a manifest associated with the IoT element being manipulated and connective relationships between IoT elements in a rule that is currently being modified. For example, if the user is attempting to move an IoT element to another location within a flow, the rule management module 215 may refer to a manifest associated with the IoT element or other information to determine which of the empty locations in the flow are configured to accommodate the IoT element.

If the action is not permissible, the rule management module 215 transmits 835 a notification to the client application indicating that the action is not permissible. Such a notification may prompt the client application to indicate to the user that the action cannot be taken.

Conversely, if the action is determined as being permissible by the rule management module 215, the rule being created or modified is updated 840 by the rule management module 215. The rule management module 215 may also return 845 confirmation indicating that the rule is updated.

In response to receiving the confirmation, the client application may update 850 the user interface associated with the rule to show the creation of or modification to the rule.

The steps of process illustrated in FIG. 8 are merely illustrative. The sequence of steps may be modified and some steps may be omitted. For example, determining whether the intended action is permissible may be performed solely by the client application or the unified control platform 104. Further, the sending 845 of confirmation may be performed before updating 840 the rule or in parallel with the updating 840 of the rule.

### Example of Creating a Flow

A flow, alternatively referred to as a rule, is a collection of multiple elements and interactions between the elements, and is configured to perform one or more actions based on information provided by the IoT device or service attached to each element. Actions performed as part of the flow can be conditional in nature, and depend on the information reported by the multiple elements that compose the flow. Simple flows involve basic “if-then” statements, while more complex flows involve complex combinational logic and multi-step actions that require inputs from a multitude of IoT elements.

Flows may be created one element at a time. A user performs one or more drag-and-drop actions to select elements and places them in a grid displayed by the client application.

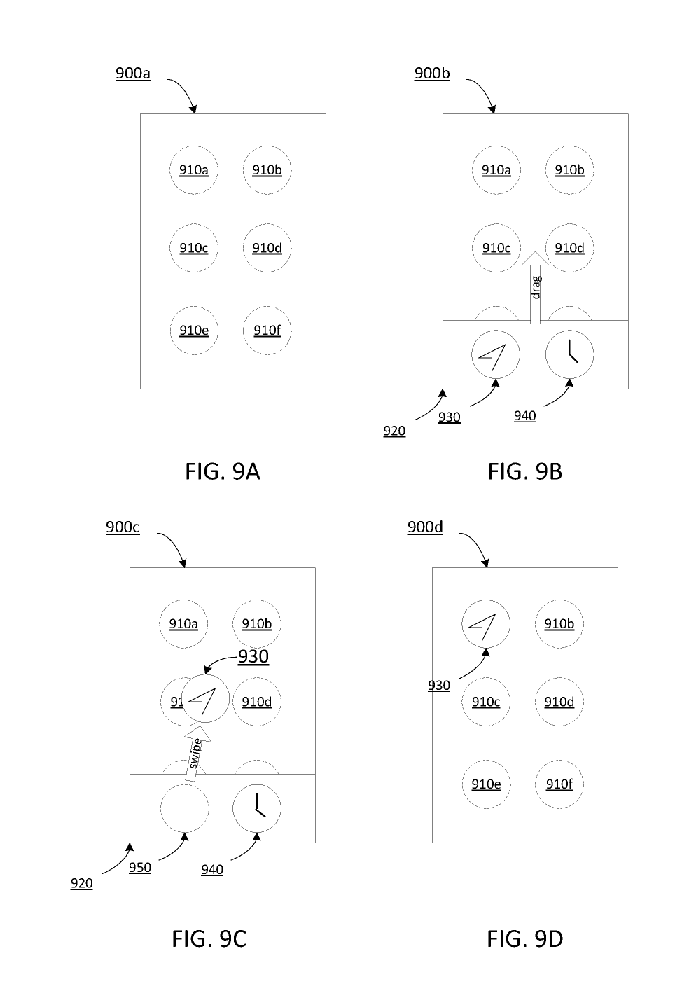

FIGS. 9A through 9D are graphical user interface diagrams illustrating the process of adding an instance to create a new flow, according to one embodiment. The graphical user interface screen 900a features an empty grid consisting of six instance slots 910a, 910b, 910c, 910d, 910e, and 910f. Each of the element slots 910 can accommodate a single element.

In the screen 900b, a user performs a drag action from the bottom of the screen, causing a tray 920 to be displayed. The tray 920 contains two elements: a location element 930 and a date/time element 940.

In 900c, the user places his or her finger on the location instance 930 and swipes, causing the element 930 to be moved away from the tray 920 and into the grid area containing the element slots 910. An empty element lot 950 is left in the tray 920 where the location element 930 used to be.

In 900d, the user places the location element 930 into element slot 910a, and the tray 920 is removed from view.

In one embodiment, software executing in the client application is configured to detect when the user has released an element at a given location within the grid. Subsequent to this detection, the software identifies the nearest element slot and places the released element in that slot. This “snap” capability makes the user interface easier to use and saves the user from having to carefully drag an element to the exact desired location.

When such action to place the location element 930 into element slot 910a is taken on the client application, the client application first determines if such action is permissible. If the action is permissible, then the client application sends action information to the unified control platform, as described above with reference to FIG. 8.

Combinational Logic within a Flow

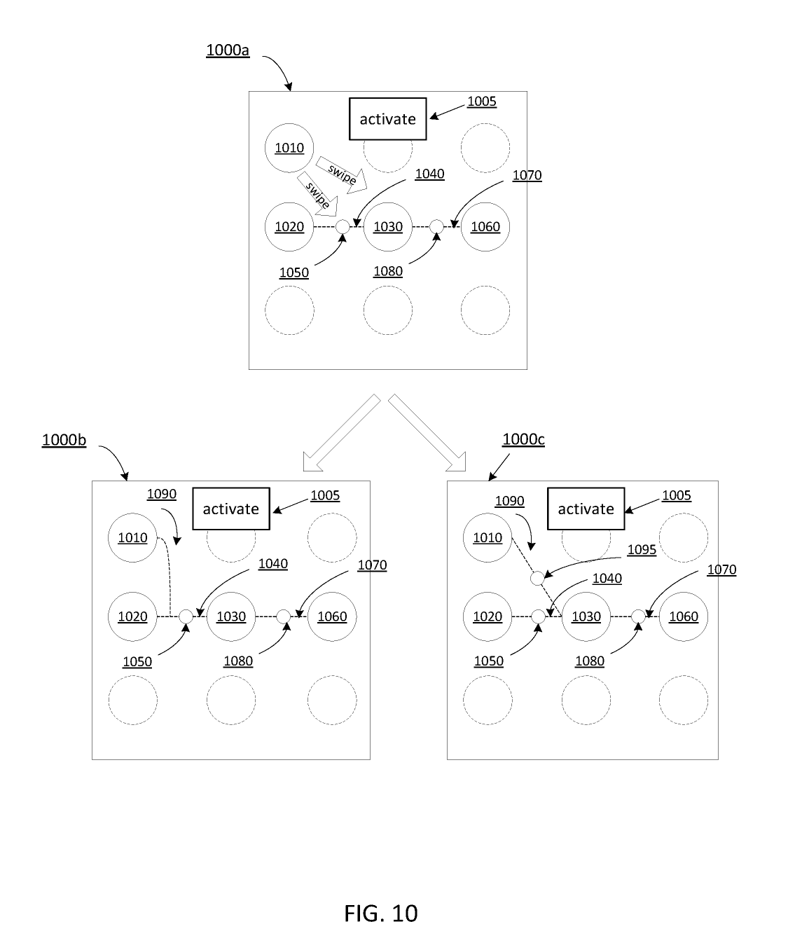

FIG. 10 is a graphical user interface illustrating a process of connecting an element to an existing flow, according to one embodiment. The graphical user interface screen 1000a depicts a grid as displayed to the user in the client application. Elements 1010, 1020, 1030, and 1060 have been placed on the grid previously. In screen 1000a, element 1010 is isolated while element 1020 is connected to element 1030 via connector 1040.

A control button 1050 allows the user to configure or customize the interaction between elements 1020 and 1030. The interaction may involve a condition or requirement that must be satisfied by element 1020 in order for an action represented by element 1030 to be performed. Element 1030 is further connected to element 1060 via connector 1070. A control button 1060 allows the user to configure or customize the interaction between the two elements.

In the configuration just described, element 1020 may represent a physical device such as a thermostat or sensor. As described previously, the element 1030 may represent an action that is performed if and only if a condition or requirement is satisfied by element 1020. Connector 1040 expresses this conditional relationship, and control button 1050 allows the user to modify it. Likewise, element 1060 could represent a further action to be performed by another IoT device or service, contingent upon an outcome of the action performed by the element 1030. The conditional relationship between elements 1030 and 1060 is represented by connector 1070, and control button 1080 allows the user to modify it.

A user can activate a flow before it can perform the functions described by its elements and the connections between them. An Activate button 1005 at the top of the screen 1000a, when clicked, prompts the client application to check the validity of the flow(s) created by the user. In a typical embodiment, this involves verifying the compatibility of each of the elements included in the flow. Software executing either on the client application or within the unified control platform compares the allowed functions of each of the IoT device or services represented by the elements, and ensures that they can interact in the manner described by the flow. If this verification is successful, the flow becomes activated and is ready for use. If the verification is unsuccessful, then the client application displays an error message to the user.

A user may connect an element to an existing flow to extend its functionality by dragging or swiping the desired element to a location in the existing flow. Returning to the screen 1000a, the user desires to connect element 1010 to the existing flow composed of elements 1020, 1030, and 1060. The user can effect this connection in one of two ways—either by swiping from element 1010 toward control button 1050, or by swiping from element 1010 toward element 1030. The swipe action must be performed in such a way as to be distinguishable from other swipe gestures.

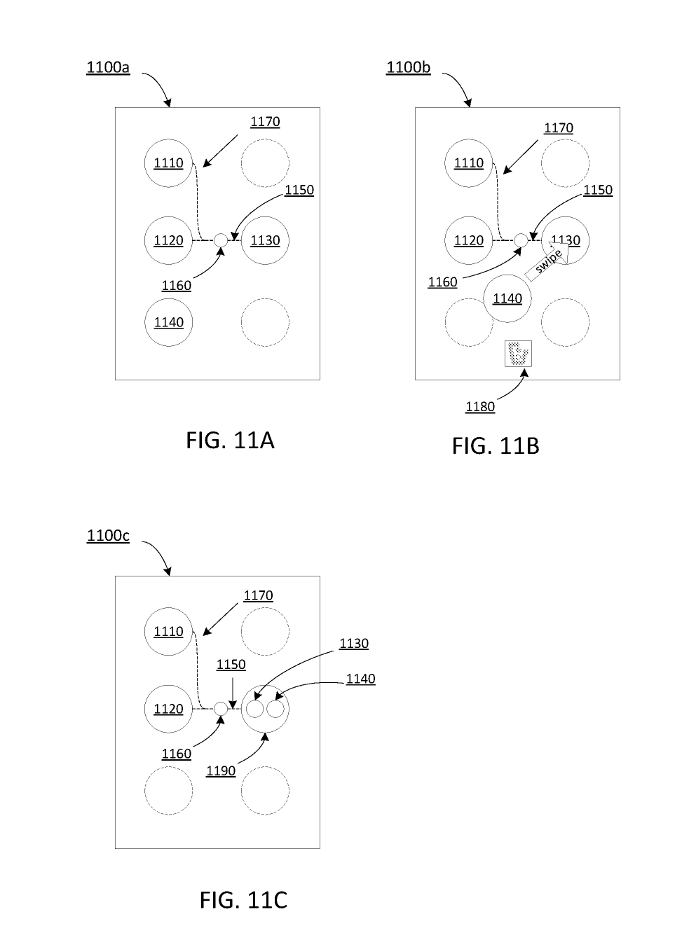

In one embodiment, the user initiates the swipe action by placing a single finger onto the screen over the element. If the user subsequently begins moving his or her finger before a predetermined length of time has passed, then the client application interprets the action as intended to create a connection between the element and another element(s). If instead, the user initiates keeps his or her finger stationary for longer than the predetermined duration, then the client application interprets the action differently (as described below in detail with reference to FIG. 11).

Screen 1000b depicts the result of swiping from element 1010 to control button 1050. This type of connection represents an “And” operation. A new connector 1090 is displayed, connecting element 1010 to connector 1040. Viewed left to right, connector 1090 intersects connector 1040 “before” control button 1050. This means that the condition expressed in control button 1050 is applied to both elements 1010 and 1020. The action associated with element 1030 will be performed if and only if the condition expressed in control button 1050 is satisfied by both elements 1010 and 1020.

Screen 1000c depicts the result of swiping from element 1010 to element 1030. This type of connection represents an “OR” operation. The connection 1090 is displayed, except it connects element 1010 to element 1030, and it features its own control button 1095. Control button 1095 expresses a condition pertaining to the physical IoT device represented by element 1010. The action associated with element 1030 will be performed if either the condition expressed in control button 1050 or the condition expressed in control button 1095 is satisfied.

In addition to creating flows by connecting elements placed in a grid of the client application, a user can also modify flows by moving elements themselves. FIGS. 11A through 11C are graphical user interface diagrams illustrating the process of moving an instance into an existing flow, according to one embodiment. The screen 1100a features a flow comprised of three elements 1110, 1120, and 1130. Element 1120 is connected to element 1130 via connector 1150 which features a control button 1160. Connector 1170 couples element 1110 to element 1130 via control button 1160. As described in FIG. 10, this arrangement represents an AND operation in which whatever condition expressed in control button 160 must be satisfied by both elements 1110 and 1120 in order for an action associated with element 1030 to be performed. Finally, a fourth element 1140 is placed on the grid but is isolated.

A user may desire to add element 1140 to the existing flow containing elements 1110, 1120, and 1130. In the graphical user interface screen 1100b, the user moves element 1140 by performing a swipe action. The user can initiate this swipe action by placing a single finger on the screen of the display device over the element and, holding the finger to the screen, dragging the element away from its initial position. The element 1140 moves away from its previous slot, and the user is free to drag the element to a new position on the screen. At this point, a trashcan icon 1180 is displayed at the bottom of screen 1100b. The user may delete element 1140 by dragging it over the trashcan 1180 and releasing it.

In a typical embodiment, element 1140 may be similar in kind to element 1130. For example, they could both represent a type of IoT light bulb. The user may wish to add element 1140 to the flow in such a way that element 1140 duplicates the actions of element 1130. The user can accomplish this by dragging element 1140 over element 1130 and releasing it. The screen 1100c illustrates the effect of this action. Miniature representations of elements 1130 and 1140 are displayed in a container 1190, which now occupies the same position as element 1130 in screens 1100a and 1100b.

As described above, a swipe action intended to move an element from one position in the grid to another position in the grid must be performed in such a way as to be distinguishable from swipe actions intended to perform other actions, such as the creation of a connection between two elements. In one embodiment, if the user places his or her finger onto the screen over the element and holds it stationary for longer than a predetermined length of time, then the client application interprets the action as intended to move the element. If instead, the user holds his or her finger stationary for shorter than the predetermined length of time, then the client application interprets the action as intended to create a new connection (as described above in detail with reference to FIG. 10).

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

What is claimed is:

1. A method for configuring operation of Internet-of-Things (IoT) devices, the method comprising:
displaying, by a first computing device, a user interface including a first graphical user interface element representing a first IoT element;
detecting, by the first computing device, an action associated with the first graphical user interface element by a user to create or modify a rule defining an operation or state of the first IoT element relative to at least a second IoT element;
sending, by the first computing device, action information indicating the action performed by the user to a second computing device to cause the second computing device to create or modify the rule stored in the second computing device; and
displaying, by the first computing device, creating or modifying of the rule.

2. The method of claim 1, wherein the user interface comprising a grid onto which graphical user elements representing IoT elements including the first graphical user element are dragged and dropped.

3. The method of claim 1, further comprising receiving, by the first computing device, a confirmation from the second computing device indicating that the rule is created or modified on the second computing device responsive to determining at the second computing device that the action as indicated in the action information is permissible based on a description of the first IoT element or a description of the second IoT element.

4. The method of claim 3, wherein the action information is sent from the first computing device to the second computing device responsive to determining at the first computing device that the action is permissible.

5. The method of claim 1, wherein the rule includes a condition associated with the operation or state of the first IoT element and an action performed by the first IoT element or the second IoT element responsive to satisfying the condition.

6. The method of claim 5, wherein the condition is satisfied by the first IoT element performing a predetermined operation or being placed in a predetermined state.

7. The method of claim 5, wherein the action is a swipe motion from the first graphical user interface element to a second graphical user interface element representing the second IoT element, and wherein the operation or state of the first IoT element is a condition for the second IoT element to take a predetermined action.

8. The method of claim 5, wherein the action is a swipe motion from the first graphical user interface element to a location on the user interface screen between a second graphical user interface element and a third graphical user interface element, the second graphical user interface element representing the second IoT element, the third graphical user interface element representing a third IoT element, the rule modified responsive to the action to establish an AND condition for operating the third IoT element based on the operation or states of the first and second IoT elements.

9. The method of claim 5, wherein the action is a swipe motion from the first graphical user interface element to a second graphical user interface element connected to a third graphical user interface element, the second graphical user interface element representing the second IoT element, the third graphical user interface element representing a third IoT element, the rule modified responsive to the action to establish a OR condition for operating the second IoT element based on the operation or states of the first and third IoT elements.

10. The method of claim 1, further comprising:
making an untethering motion on the user interface screen to unlock a third graphical user interface element representing a third IoT element from an original location; and
making a swiping motion on the user interface screen to move the third graphical user interface element onto a second user graphical user interface element representing the second IoT element to cause grouping of the second and third IoT element into a single container.

11. The method of claim 1, wherein the user interface screen comprises graphical user elements representing IoT elements in a tray displayed at an edge of the user interface.

12. A non-transitory computer readable storage medium storing instructions for configuring operation of Internet-of-Things (IoT) devices, the instruction when executed by a processor causing the processor to:
display, by a first computing device, a user interface screen including a first graphical user interface element representing a first IoT element;
detect an action associated with the first graphical user interface element by a user to create or modify a rule defining operation or state of the first IoT element relative to at least a second IoT element;
send action information indicating the action performed by the user from the first computing device to a second computing device to cause the second computing device to create or modify the rule stored in the second computing device; and
display, by the first computing device, creating or modifying of the rule.

13. The computer readable storage medium of claim 12, wherein the user interface comprising a grid onto which graphical user elements representing IoT elements including the first graphical user element are dragged and dropped.

14. The computer readable storage medium of claim 12, further comprising receiving confirmation from the second computing device indicating that the rule is created or modified on the second computing device responsive to determining at the second computing device that the action as indicated in the action information is permissible based on a description of the first IoT element or a description of the second IoT element.

15. The computer readable storage medium of claim 12, wherein the action information is sent from the first computing device to the second computing device responsive to determining at the first computing device that the action is permissible.

16. The computer readable storage medium of claim 12, wherein the rule includes a condition associated with the operation or state of the first IoT element and an action performed by the first IoT element or the second IoT element responsive to satisfying the condition.

17. The computer readable storage medium of claim 16, wherein the action is a swipe motion from the first graphical user interface element to a second graphical user interface element representing the second IoT element, and wherein the operation or state of the first IoT element is a condition for the second IoT element taking a predetermined action.

18. The computer readable storage medium of claim 16, wherein the action is a swipe motion from the first graphical user interface element to a location on the user interface between a second graphical user interface element and a third graphical user interface element, the second graphical user interface element representing the second IoT element, the third graphical user interface element representing a third IoT element, the rule modified responsive to the action to establish an AND condition for operating the third IoT element based on the operation or states of the first and second IoT elements.

19. The computer readable storage medium of claim 16, wherein the action is a swipe motion from the first graphical user interface element to a second graphical user interface element connected to a third graphical user interface element, the second graphical user interface element representing the second IoT element, the third graphical user interface element representing a third IoT element, the rule modified responsive to the action to establish an OR condition for operating the second IoT element based on the operation or states of the first and third IoT elements.

20. A first computing device, comprising:
a processor; and
a non-transitory computer readable storage medium comprising instructions, the instructions when executed causing a processor to:
display, by the first computing device, a user interface screen including a first graphical user interface element representing a first IoT element;
detect an action associated with the first graphical user interface element by a user to create or modify a rule defining operation or state of the first IoT element relative to at least a second IoT element;
send action information indicating the action performed by the user from the first computing device to a second computing device to cause the second computing device to create or modify the rule stored in the second computing device; and
display, by the first computing device, creating or modifying of the rule.
